(19) United States
(12) Patent Application Publication
(10) Pub. No.: US 2011/0033189 A1
(43) Pub. Date: Feb. 10, 2011

(54) RETURN PATH COMPLIANCE IN NETWORKS

(75) Inventors: Mark R. Biegert, Maple Grove, MN (US); Peter O. Lee, Rogers, MN (US)

Correspondence Address: SHUMAKER & SIEFFERT, P. A., 1625 RADIO DRIVE, SUITE 300, WOODBURY, MN, 55125, US

(73) Assignee: Calix Networks, Inc., Petaluma (US)

(21) Appl. No.: 12/260,665

(22) Filed: Oct. 29, 2008

(51) Int. Cl. H04B 10/12; H04B 10/00

(52) U.S. Cl. 398/115; 398/200

(57) ABSTRACT

This disclosure is directed to techniques for facilitating return path compliance in networks. A device, such as an optical network terminal (ONT), may, for example, buffer a digital representation of an upstream analog signal to facilitate return path compliance specified by a Data Over Cable Service Interface Specification (DOCSIS) 3.0 standard. The ONT may comprise a first conversion module that converts an upstream analog signal into a corresponding digital signal and a signal detection module that determines whether the upstream analog signal represents a valid upstream communication. The device may further comprise a buffer that buffers the corresponding digital signal while the signal detection module makes the determination, a second conversion module that converts the buffered digital signal into a reconverted upstream analog signal upon the determination that the upstream analog signal is valid and a laser that transmits the reconverted upstream analog signal via a fiber optical cable.

### TECHNICAL FIELD

This disclosure relates to optical networks and, more particularly, the transport of upstream RF Cable Modem (CM) and Set-Top Box (STB) traffic over optical networks.

### BACKGROUND

A cable network typically includes at least one headend system that services a plurality of subscriber devices. Generally, the headend system is stored within a central office of a cable service provider and includes one or more Cable Modem Termination Systems (CMTSs) and Conditional Access Servers (CASs) that access a backbone network (such as the Internet). Each of the CMTSs and CASs may service Customer Premise Equipment (CPE), such as CMs and STBs. Traditionally, the cable network includes coaxial cable that is laid up to and installed inside a subscriber's premises to couple the CMTSs and CASs of the headend system to the CPE (which may also be referred to as “subscriber devices”). Over this coaxial cable the CMTSs, CASs, and subscriber devices communicate via radio frequency (RF) signals.

While coaxial cable provides sufficient bandwidth to transmit television and low-speed Internet services, the recent growth of the Internet and desire to provide high-speed Internet access via the cable network has begun to generate new bandwidth concerns. In response to these concerns, most cable service providers have upgraded links coupling the headend system to the backbone network from coaxial cable to higher bandwidth fiber optical cable to facilitate higher bandwidth access to the backbone network, creating what may be referred to as a “hybrid fiber coaxial network” or “HFC network.”

Some cable service providers also have begun to upgrade the coaxial cable extending from the CMTSs to the subscriber premises but most have not, as of yet, extended the fiber optical cable all the way, or the “last mile,” to the subscriber's premises. Recently, cable service providers have begun to consider upgrading this last mile to fiber optic cable to offer a service known as fiber-to-the-home (FTTH) or fiber to the premises (FTTP). In this all-fiber network, all communications typically occur via a packet-based protocol, such as the Internet protocol (IP).

Although all-fiber networks may offer relatively higher transmission speeds and bandwidth when compared to HFC networks, upgrading to an all-fiber network may require large upfront expenditures. To support communications via the packet-based protocol, upgrading the last mile may require replacing not only the coaxial cable to the customer premises but also the CMTSs, CASs, any CPE or subscriber devices, and the coaxial cable installed within the subscriber's premises. As a result, an intermediate upgrade strategy has been proposed where RF signals are transmitted over fiber optic links, which are made of glass and cannot directly transport electrical signals. The electrical signals from the subscriber equipment may be used to modulate light generating devices, such as lasers. Using RF-modulated light allows fiber optic cables to carry the same RF signals as coaxial cable. The resulting network may be referred to as an RF Over Glass (RFOG) network.

As an RFOG network simply converts the RF signals to a form that can be transported over optical fiber and converted back to RF at the central office, the cable service provider can continue to use his RF infrastructure at the central office and the home. They do not need to upgrade the CMTS, CASs, CPE or subscriber devices, and coaxial cable located within the subscriber's premises, thereby substantially reducing upfront costs required when compared to upgrading directly to the all-fiber network. Instead, the cable service provider may lay fiber optic cable to the subscriber's premises, implement the required electrical-to-optical (E-to-O) and optical-to-electrical (O-to-E) converters at the ends of the fiber optic cable, and at some later time, when the service provider has sufficient capital, convert the RFOG network to a dedicated optical network that communicates using a packet-based protocol, such as a gigabyte passive optical network (GPON) protocol or active Ethernet protocol.

### SUMMARY

This disclosure is directed to devices and methods for facilitating return path compliance in networks. In particular, various aspects of this disclosure may be applicable to return path compliance in an RFOG network. A “return path” refers to upstream communications from subscriber devices to a headend system, such as a Cable Modem Termination System (CMTS) located at a central office of a service provider. Commonly, to maintain compliance with various return path standards, return path communications are to be communicated at a specified return path rate. To date, RFOG networks have been implemented using analog electronics at the central office and the ONTs. In some instances, the return path specifications for turn-on and turn-off times of standards specified for Hybrid Fiber Coaxial (HFC) networks is higher than can be met by an analog RFOG system. Thus, when upgrading from an HFC network to an analog RFOG network, the resulting RFOG network may not be upgradable to the higher speed HFC standards (like DOCSIS 3.0).

In one embodiment, a method comprising converting an upstream analog signal into a corresponding digital signal, determining whether the upstream analog signal represents a valid upstream communication based on the corresponding digital signal, buffering the corresponding digital signal while making the determination, converting the buffered digital signal into a reconverted upstream analog signal upon determining that the upstream analog signal is a valid upstream communication, and transmitting the reconverted upstream analog signal via a fiber optical cable.

In another embodiment, a device comprising a first conversion module that converts an upstream analog signal into a corresponding digital signal, a signal detection module that determines whether the upstream analog signal represents a valid upstream communication based on the corresponding digital signal, a buffer that buffers the corresponding digital signal while the signal detection module makes the determination, a second conversion module that converts the buffered digital signal into a reconverted upstream analog signal upon the signal detection module determining that the upstream analog signal is a valid upstream communication, and a laser that transmits the reconverted upstream analog signal via a fiber optical cable.

In another embodiment, a device comprising a first means for converting an upstream analog signal into a corresponding digital signal, a means for determining whether the upstream analog signal represents a valid upstream communication based on the corresponding digital signal, a means for buffering the corresponding digital signal while the signal detection module makes the determination, a second means for converting the buffered digital signal into a reconverted upstream analog signal upon the signal detection module determining that the upstream analog signal is a valid upstream communication, a means for transmitting the reconverted upstream analog signal via a fiber optical cable.

In another embodiment, a system comprising, at least one subscriber devices that transmits an upstream analog signal, a network, and a device coupled to the network via a fiber optical cable. The device comprising a first conversion module that converts the upstream analog signal into a corresponding digital signal, a signal detection module that determines whether the upstream analog signal represents a valid upstream communication based on the corresponding digital signal, a buffer that buffers the corresponding digital signal while the signal detection module makes the determination, a second conversion module that converts the buffered digital signal into a reconverted upstream analog signal upon the signal detection module determining that the upstream analog signal is a valid upstream communication, and a laser that transmits the reconverted upstream analog signal via the fiber optical cable.

In another embodiment, a computer-readable medium comprising instructions that cause a programmable processor to convert an upstream analog signal into a corresponding digital signal, determine whether the upstream analog signal represents a valid upstream communication based on the corresponding digital signal, buffer the corresponding digital signal while making the determination, convert the buffered digital signal into a reconverted upstream analog signal upon determining that the upstream analog signal is a valid upstream communication, and transmit the reconverted upstream analog signal via a fiber optical cable.

The details of one or more embodiments are set forth in the accompanying drawings and the description below. Other features, objects, and advantages of the techniques of this disclosure will be apparent from the description and drawings, and from the claims.

### BRIEF DESCRIPTION OF DRAWINGS

FIG. 1 is a block diagram illustrating a portion of an example Radio Frequency Over Glass (RFOG) network.

FIG. 2 is a block diagram illustrating an example Optical Network Terminal (ONT) in more detail.

FIG. 3 is a block diagram illustrating an example physical implementation of the ONT of FIGS. 1 and 2 in further detail.

FIG. 4 is a flow diagram illustrating example operation of an ONT performing the techniques described in this disclosure.

FIG. 5 is a block diagram illustrating another example physical implementation of the ONT of FIG. 1.

### DETAILED DESCRIPTION

This disclosure is directed to devices and methods for facilitating RF return path compliance in optical networks. In accordance with the techniques described in this disclosure, a device, such as an Optical Network Terminal or Optical Node Terminal (ONT), responsible for conveying return path or upstream communications from subscriber devices to a CMTS or CAS in an RFOG network, may communicate upstream or return path signals in compliance with a return path rate. This compliance may be ensured through buffering, which enables the ONT to overcome deficiencies associated with analog power detection. That is, the ONT, acting as a transparent device in the RFOG network, may detect when a subscriber device transmits a valid upstream RF communication, and upon detecting such transmission, convert the RF signal to an optical signal for transmission upstream to the CMTS.

Analog detection may suffice for lower return path rates, but when higher return path rates are required, the analog RF power detection hardware cannot detect the presence of the RF signal fast enough to turn on the laser during the first symbol of the cable modem or STB RF transmission. Thus the beginning of the packet transmission may be corrupted, making the packet unintelligible by the intended receiver. Similarly, the analog RF power detection hardware cannot detect the end of the RF signal fast enough to ensure that it will turn off the laser fast enough to avoid transmitting simultaneously with another laser on another ONT. Simultaneous laser transmissions may cause a phenomenon known as “optical beat interference” and result in loss of upstream data at the end of an RF transmission.

By converting the RF signal to digital form and buffering this data, the ONT can ensure that no RF data is lost while the ONT is determining exactly when the RF transmission started. Once the determination of an RF transmission has occurred, the ONT can begin transferring the buffer contents to a digital to analog (D/A) converter and upstream optical transmitter. Similarly, the ONT can determine exactly when the RF transmission ends, enabling it to turn off the upstream transmission at the proper time. Knowing exactly when the upstream RF transmission begins and ends will reduce, if not eliminate, the potential for both corrupting the front end of an RF transmission or causing optical beat interference at backend of an RF transmission.

For example, an ONT may receive an upstream analog signal, e.g., an RF signal, from a subscriber device and convert the analog signal into a corresponding digital signal. The ONT may then determine whether the upstream analog signal represents a valid upstream communication based on the corresponding digital signal. That is, the ONT may analyze the digital signal to determine whether the corresponding upstream analog signal represents a valid upstream communication. The ONT may include a buffer or other memory to buffer the corresponding digital signal such that none of the analog signal is lost while making the determination. The ONT may next convert the buffered digital signal back into the upstream analog signal upon determining that the analog signal is a valid upstream communication. In other words, upon determining that the buffered analog signal is valid through analysis of the corresponding digital signal, the ONT converts the buffered digital signal back into the analog signal so as not to lose any data while not generating upstream light that could conflict with the transmissions from other ONTs.

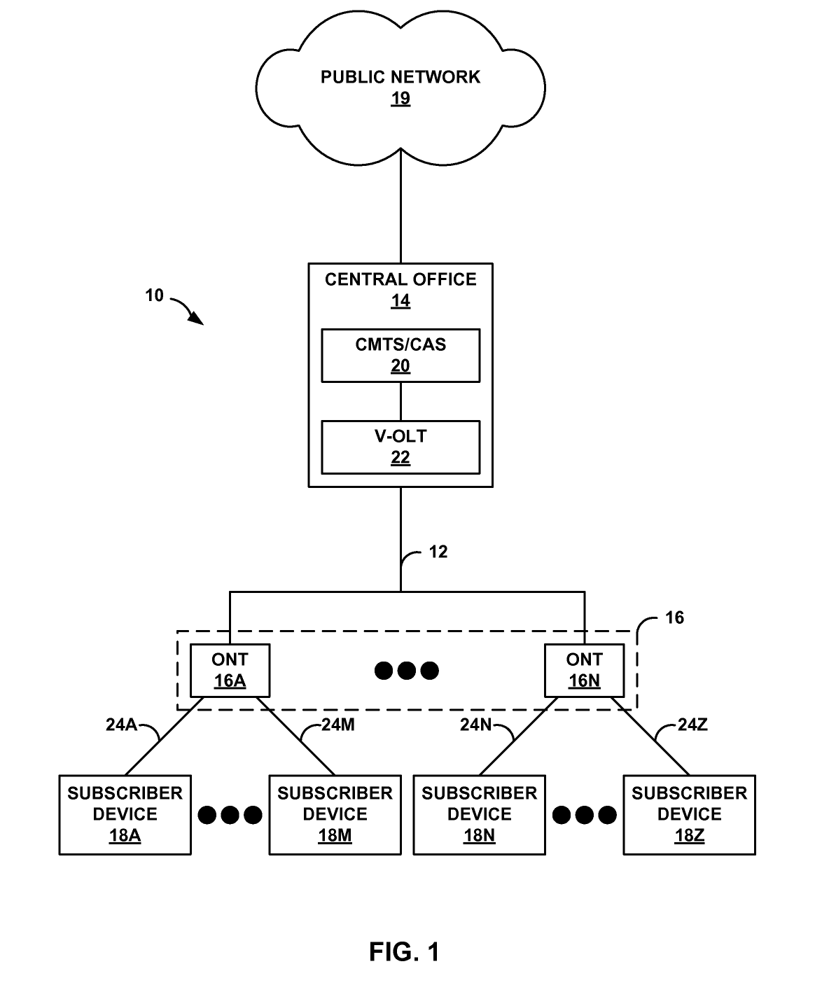

FIG. 1 is a block diagram illustrating a portion of an example Radio Frequency Over Glass (RFOG) network 10. RFOG network 10 includes one or more fiber optical cables or fiber optical links 12 over which radio frequency (RF) signals may be transmitted as optical signals. The RF signal may comprise electrical analog signals, which may be converted from electrical to optical signals. The optical signals may retain the data of the electrical analog signals and transmitted as bursts of light or optical signals via links 12. RFOG network 10 is one example of an RFOG network, and should not be considered limiting of this disclosure.

In the example of FIG. 1, RFOG network 10 includes a central office 14 and a plurality of Optical Network Terminal 16A-16N (“ONTs 16”). Optical network terminals 16 may also be referred to as Optical Node Terminals 16. Optical network terminal and optical node terminal generally refer to the same type of device and each name may be used interchangeably. Central office 14 may support delivery of voice, data and/or video services to ONTs 16. For example, central office 14 may receive data, such as voice data, Internet traffic or packets, television signals, or the like, convert this data to RF signals, further convert the RF signals to corresponding optical signals, and transmits those signals to ONTs 16. ONTs 16 may receive these optical signals and convert those optical signals back into RF signals for delivery to subscriber devices 18A-18Z (“subscriber devices 18”).

Central office 14 may represent a structure, building, or other area for housing one or more headend systems and/or service provider equipment. Central office 14 may be owned by a network service provider that provides access to one or more networks via RF communications or signals. For example, central office 14 may house a headend system for a cable company or enterprise that provides access to one or more services, such as a public network (e.g., the Internet), television content or channels, the public switched telephone network (PSTN), and Voice over Internet Protocol (VoIP). In the example of FIG. 1, central office 14 connects to public network 19, but in other instances, central office 14 may connect to any type of network that provides one or more of these services, where the connection occurs via a fiber optical cable or link, satellite, or any other type of wired or wireless communication medium.

Central office 14 includes an exemplary headend system, e.g., Cable Modem Termination System/Conditional Access System 20 (“CMTS/CAS 20”), that interfaces with public network 19 to provide access to one or more of the above described services. CMTS/CAS 20 typically is responsible for controlling the RF communications both from CMTS/CAS 20 to subscriber devices 18 (so-called “downstream” communications) and from subscriber devices 18 to CMTS/CAS 20 (so-called “upstream” communications). RF communications may refer to one or more of control communications, admin communications, configuration commands, status communications or any other RF communications transmitted in either the upstream or downstream direction. Upstream RF communications in particular may refer to upstream communications from applications, such as cable set-top boxes, Internet browsers, and other Internet or cable system-related applications. These upstream RF communications may, for example, comprise analog representations of Hyper-Text Transfer Protocol requests or other web-based or Internet-based communications, and requests to change television channels or access content associated with a selected channel. The upstream RF communications may also comprise administrative communications regarding requests for additional transmission times or other status and/or administrative activities.

CMTS/CAS 20 may designate certain timeslots during which downstream and upstream RF communications are to occur, as well as specify timeslots during which administrative and other issues may be addressed and/or resolved. CMTS/CAS 20 may also translate RF signals into packets for transmission upstream to public network 19 and translate packets received from public network 19 into RF signals for transmission downstream to subscriber devices 18. The translation may involve converting the analog RF signals into digital signals and then packetizing portions of the digital signal. That is, the digital signal may be segmented into discrete portions and each portion may be transmitted in a payload of a packet. CMTS/CAS 20 therefore may represent a network device or controller that controls the flow of RF communications within the cable network, which in this instance is represented by RFOG network 10. In addition, CMTS/CAS 20 may represent a network device for converting packets, cells, or other network data units into RF signals and RF signals into the network data units.

To enable the communication of RF signals over fiber optical cables 12, central office 14 further includes a video optical line terminal 22 (“V-OLT 22”). A V-OLT consists of a forward path E-to-O transmitter (e.g. laser) and a reverse path O-to-E receiver (e.g. photodiode). While shown as including a single V-OLT 22, central office 14 may include a plurality of V-OLTs 22 that each services a group of ONTs 16. Each of ONTs 16 services a subset of subscriber devices 18. In the example illustrated in FIG. 1, ONT 16A services subscriber devices 18A-18M and ONT 16B services subscriber devices 18N-18Z. CMTS/CAS 20 may, in some instances, service up to 4000 subscriber devices while V-OLT 22 may service up to 64 ONTs 16. Assuming an ONT services, at most, 10 subscriber devices, an V-OLT may therefore only service 640 subscriber devices. The above numbers, e.g., 10 and 640, are provided as an example to illustrate capabilities of exemplary ONTs and V-OLTs. In other instances, ONTs may service more or less subscriber devices and, as a result, V-OLTs may service more or less subscriber devices. Therefore, central office 14 may include a plurality of V-OLTs 22 for each CMTS/CAS 20. However, for ease of illustration, only a single V-OLT 22 is shown in FIG. 1. Therefore, the techniques of this disclosure should not be limited to this exemplary embodiment.

V-OLT 22 may include hardware and/or software necessary to transparently convert an RF signal to an optical signal and an optical signal to an RF signal. In particular, V-OLT 22 may include an electrical-to-optical (“E-to-O”) converter that converts downstream RF communications, which are electric signals, received from CMTS/CAS 20 to optical signals for transmission downstream over fiber optical cable 12. V-OLT 22 may also include an optical-to-electrical (“O-to-E”) converter that converts upstream optical signals received via fiber optical cable 12 to upstream RF signals, which are electric signals, for delivery to CMTS/CAS 20. V-OLT 22 may therefore represent an intermediate network device capable of converting optical signals to electrical signals and electrical signals to optical signals. The conversion of the optical signals to RF signals and conversion of RF signals to optical signals may be “transparent,” in that CMTS/CAS 20 may be unaware of the conversion the signals.

Likewise, each of ONTs 16 may include similar hardware and/or software to that of V-OLT 22 in order to convert downstream optical signals back into downstream RF signals for delivery to subscriber devices 18 and upstream RF signals into upstream optical signals for delivery to central office 14 via fiber optical cable 12. In other words, each of ONTs 16 may include an O-to-E converter to convert downstream optical signals received via fiber optical cable 12 to RF signals for delivery via a respective one of RF cables 24A-24Z (“RF cables 24”) to subscriber devices 18. Each of ONTs 16 may also include an E-to-O converter to convert upstream RF signals received from subscriber devices 18 via respective RF cables 24 to optical signals for delivery upstream to central office 14 via fiber optical cable 12. ONTs 16 may also each represent an intermediate network device capable of converting optical signals to electrical signals and electrical signals to optical signals. Again, such conversions may be “transparent” from the perspective of subscriber devices 18 in that subscriber devices 18 may be unaware of the conversion. ONTs may also, in addition to the RF conversion described herein, support other optical network architectures or optical protocols, such as Passive Optical Network (PON) or Active Ethernet architectures.

By including such hardware and/or software in both V-OLT 22 and each of ONTs 16, RF communications may be transparently conveyed across fiber optical links 12 resulting in an RFOG network, such as RFOG network 10. CMTS/CAS 20 and subscriber devices 18 may therefore be unaware of the intermediate conversion of RF communications or signals to optical signals. Thus, CMTS/CAS 20 and subscriber devices 18 typically need not take any additional action or perform any additional steps to communicate in an RFOG network, such as RFOG network 10.

In general, due in part to the transparent nature of the network, RFOG network 10 may provide a number of benefits to the network service provider, e.g., the cable service provider company in this instance. One possible benefit of RFOG network 10 is that the transition and costs associated with the transition, from an RF network to a full optical network, such as to a Gigabyte Passive Optical Network (GPON), may occur, and accrue, gradually over time, respectively. That is, the cable company or other service provider may expend capital to upgrade a traditional RF network first to RFOG network 10 and then, when, for example, demand for high-speed access to the above described services increases in certain areas of the network and bandwidth limitations become a pressing concern or when sufficient capital exists, expend this additional capital to upgrade RFOG network 10 to a full optical network.

To upgrade a conventional RF network to RFOG network 10, the cable company or network service provider may lay fiber optical cable 12 between central office 14 and subscriber premises, e.g., a subscriber's home or place of business in which one or more of subscriber devices 18 reside. Fiber optical cable 12 may be laid alongside cables that carry electrical RF signals, e.g., coaxial cable. At some later point, the cable company may purchase V-OLT 22 and ONTs 16 and install V-OLT 22 in central office 14 and ONTs 16 at respective subscriber's premises. The cable company may then begin using the fiber optical cable 12 to transmit RF signals, as described above. This upgrade may therefore occur over time and delay the initial upfront costs associated with upgrading directly from an RF network to a full optical network. By delaying the expenditure of capital, the upgrade may be more manageably achieved by those cable companies or other network service providers that lack the necessary capital to upgrade directly to a full optical network.

Additionally, RFOG network 10 enables the continued use of conventional RF customer premise equipment (CPE) and a conventional CMTS. CPE is shown in FIG. 1 as subscriber devices 18. Subscriber devices 18 (or CPE) may each comprise set-top boxes (STBs) typically located near or proximate to a subscriber's television or other viewing device. Subscriber devices 18 may also each comprise a cable modem or any other device used to communicate via RF signals with a CMTS, such as CMTS/CAS 20. Upgrading directly to a full optical network normally entails upgrading the CPE or subscriber devices 18 (and possibly the CMTS) to devices capable of communicating according to an Internet Protocol (IP), an Ethernet protocol, and/or any other network packet- or cell-based protocol. This upgrade typically requires upgrading hundreds, if not thousands, of subscriber devices 18, which may prove prohibitively costly for cable companies or service providers having less capital on hand. However, by converting to an intermediary RFOG network, such as RFOG network 10, the cable company or service provider may delay upgrading subscriber devices 18, as RFOG network 10 continues to communicate using RF signals and not packets. As a result of not having to upgrade subscriber devices 18, RFOG network 10, as described above, may make the conversion to a full optical network more incremental and more manageable for those companies or service providers who would like to defer capital expenditures.

While RFOG network 10 may enable a cable or other service providers to delay costs and expenses associated with transitioning to a full optical network, it is possible that, upon implementing RFOG network 10, the resulting cable network may fail to comply with applicable cable network standards, especially those standards most recently adopted by the industry as a whole. For example, the Digital Video Subcommittee (DVS) of the Society of Cable Telecommunications Engineers (SCTE) working in conjunction with the American National Standards Institute (ANSI) originally proposed standards concerning the delivery of RF signals over optical fiber cable in 2002.

These standards, which can be referenced as ANSI/SCTE 55-1 (formerly DVS 178) and ANSI/SCTE 55-2 (formerly DVS 167), provided for a return path rate, or simply a return rate, of 128 Kilo-symbols (Ksym) per second (s). A symbol may represent a bit or other discrete unit of data. The return path refers to the upstream communications from subscriber devices 18 to CMTS/CAS 20. Thus, the 128 Ksym per second or 128 Ksym/s indicates the speed at which data (e.g., symbols) is to be conveyed upstream from subscriber devices 18 to CMTS/CAS 20 via RFOG network 10. More information regarding these RFOG standards can be found in ANSI/SCTE 55-1 and 55-2, titled “Digital Broadband Delivery System: Out of Band Transport Part 1: Mode A” and “Digital Broadband Delivery System: Out of Band Transport Part 2: Mode B,” each prepared by the DVS of the ANSI/SCTE, each dated 2002, both of which are herein incorporated by reference.

In 2006, however, at least one new standard governing hybrid fiber coaxial (HFC) cable networks proposed a much higher return path rate. This standard was developed by CableLabs and a number of other contributing companies, e.g., Intel, Motorola, Cisco, Netgear, etc. and is referred to as Data Over Cable Service Interface Specification (DOCSIS) 3.0. DOCSIS 3.0 provides for a 5.120×10⁶ symbols or 5.120 Mega-symbols (Msym)/s return path rate. More information regarding the DOCSIS 3.0 standard can be found in a number of DOCSIS 3.0 specifications each designated as follows: “SP-SECv3.0,” “SP-CMCIv3.0,” “SP-PHYv3.0,” “SP-MULPIv3.0,” and “SP-OSSIv3.0,” each respectively titled as follows: “Security Specification,” “Cable Modem to Customer Premise Equipment Interface Specification,” “Physical Layer Specification,” “MAC and Upper Layer Protocols Interface Specification,” and “Operations Support System Interface Specification,” each published on May 22, 2008, and each of which is also incorporated herein by reference.

Thus, a potential conflict arose between the analog RFOG implementations and the standards governing HFC networks, as the return path rate provided in the HFC DOCSIS 3.0 standard greatly exceeded the return path rate provided in the DOCSIS 1.0, 1.1, 2.0, ANSI/SCTE 55-1 and 55-2 standards. As a result, networks containing analog RFOG hardware that complied with the ANSI/SCTE 55-1 and 55-2 standards may not be upgradable to the newer DOCSIS 3.0 standard. These analog RFOG return path may only be able to support a return path rate of 128 Ksym/s instead of the DOCSIS 3.0 compliant return path rate of 5.12 Msym/s.

The failure of analog RFOG return path hardware to comply with the higher return path rates specified in DOCSIS 3.0 may significantly curtail the adoption of RFOG networks as an intermediate step to full optical networks, as service providers who deploy RFOG networks may not be able to offer those higher upstream or return path rates specified in the DOCSIS 3.0 standard. Those service providers already operating DOCSIS 3.0 compliant networks may entirely avoid RFOG networks, as ONTs failing to support the return path rate specified in DOCSIS 3.0 may limit if not entirely prevent upstream communications from occurring. This second scenario, where the ONT prevents upstream communications, may significantly limit if not prevent RFOG networks from providing Internet, VoIP and other interactive, two-way, or upstream-reliant services. The second scenario arises because of two phenomena, clipping and “optical beat interference” or “OBI” for short.

Clipping may occur when the RFOG hardware does not faithfully reproduce all the information contained in the upstream analog system. Clipping occurs because the RFOG unit takes time to determine the presence of the upstream analog transmission and during this time some information will not be transmitted upstream and will therefore be lost. Clipping is a problem that occurs at the beginning of an upstream transmission. If the RFOG hardware does not stop transmitting at the same time as the upstream RF transmission ends, there is the possibility that the lasers from two RFOG units be transmitting at the same time. When two lasers transmit at the same time on the same fiber, OBI can occur and may render the transmission unintelligible. OBI occurs when light from two or more lasers sums coherently in the receiver's photodiode rather than incoherently. Typically, coherent summing happens when the lasers' wavelengths drift close to one another. In other words, OBI can occur, for example, if more than one laser included within ONTs 16 begins transmitting at a same time. OBI can introduce interference to an extent such that optical signals received by V-OLT 22 are completely unintelligible or incomprehensible. As a result, V-OLT 22 either cannot convert the upstream optical signals back into RF signals or converts the OBI resultant noise into unintelligible RF signals. Consequently, OBI may significantly disrupt, if not prevent, upstream or return path communications.

OBI occurs in the second scenario, where conventional ONTs that operate in compliance with the ANSI/SCTE 55-1 and 55-2 standards are introduced into DOCSIS 3.0 compliant networks, as a result of a failure of conventional ONTs to quickly detect the end of upstream or return path communications and/or adjust for the time required to detect upstream or return path communications. CMTS/CAS 20, as mentioned above, assigns timeslots to each of subscriber devices 18 during which the respective subscriber devices 18 may communicate upstream.

Generally, conventional ONTs require about four microseconds (4 μs) to detect a return path signal (e.g., determine if an upstream RF signal is valid), as the first few microseconds of any RF upstream signal may not be properly distinguishable from noise. This is because the upstream RF signal may have a slow rise time and the detection hardware has unavoidable internal delays. In networks complying with the slower 128 Ksym/s return path rate, there is sufficient time for the conventional ONTs to detect the signal, turn on the laser, transmit the optical signal with insignificant clipping and turn off the laser before another laser turned on. In networks complying with the higher 5.12 Msym/s return path rate, however, these conventional ONTs may detect the signal and turn on the laser, but not turn off the laser before another ONT began transmitting, thereby causing OBI.

Moreover, in those networks complying with the higher 5.12 Msym/s return path rate, the conventional ONTs, as a result of the increased rate and 4 μs time to detect an upstream RF signal, may lose data irretrievably when deployed in these networks. Again, referring to the networks adopting the slower 128 Ksym/s return path rate for purposes of illustration, the time to communicate each symbol (T_{Symbol(SCTE)}) is approximately 7.8125 μs, which is greater than the time to detect the RF signal or 4 μs.

To arrive at this 7.8125 μs time to communicate each signal, the following is assumed:

f_{Rate(SCTE)}=128 Ksym/s.

The constant f_{Rate(SCTE)} denotes the return path rate or frequency (f) of data communications in an ANSI/SCTE 55-1 compliant network. Using f_{Rate(SCTE)}, it is possible to calculate a period (T_{Symbol(SCTE)}) required to transmit a symbol in the ANSI/SCTE 55-1 compliant network, according to the following equation (1):

T_{Symbol(SCTE)}=1/f_{Rate(SCTE)}=1/128 Ksym/s=7.812500 μs. (1)

Conventional ONTs typically do not irretrievably lose data when deployed in these ANSI/SCTE 55-1 networks, assuming in addition to the above that:

f_{Carrier(SCTE)}=8.096 Mega Hertz(MHz),

where f_{Carrier(SCTE)} denotes a common startup frequency for an ANSI/SCTE 55-1 compliant network. Using f_{Carrier(SCTE)}, it is possible to calculate a period of a carrier clock in the ANSI/SCTE 55-1 compliant network (T_{Carrier(SCTE)}) which governs all communications in a cable network, such as RFOG network 10, according to the following equation (2):

T_{Carrier(SCTE)}=1/f_{Carrier(SCTE)}=1/8.096 MHz=0.123518 μs. (2)

Based on T_{Carrier(SCTE)} and T_{Symbol(SCTE)}, it is further possible to determine the number of clock cycles required to correctly receive a symbol in an ANSI/SCTE 55-1 compliant network according to the following equation (3):

Cycles_{(SCTE)}=T_{Symbol(SCTE)}T_{Carrier(SCTE)}=63.250 clock cycles. (3)

Thus, 55-1 standard at 128K symbols per second provides 63 clock cycles to correctly determine a symbol. Because the 4 μs delay is much shorter than a symbol at this symbol rate, generally, only an insignificant fraction of a single clock cycle is lost when using an unbuffered approach, but as rates increase, this 4 μs delay will consume a larger portion of the first symbol. In fact, at the highest rates number of the leading symbols will be lost and will cause irretrievable loss of data or clipping of the upstream RF transmission.

Similar effects occur when an upstream transmission must end. The laser must also be turned off quickly enough to ensure that two lasers cannot be on simultaneously and avoid OBI. The DOCSIS standard allows 5 symbol times for turn-off time or ˜1 μs at 5/23 Msym/s (the maximum return path rate). Thus, the 4 μs detection time is not sufficient to meet the turn-off requirement either.

Thus, in networks compliant with the higher return path rate of 5.12 Msym/s, for example, the time or period these networks require to transmit a symbol (T_{Symbol(DOCSIS)}) is approximately 0.195313 μs, which is far less than the 4 μs time required by a conventional ONT to detect a symbol. To arrive at this 0.195313 μs period, the following is assumed:

f_{Rate(DOCSIS)}=5.120 Msym/s.

The constant f_{Rate(DOCSIS)} denotes the return path rate or frequency (f) of data communications in a DOCSIS 3.0 compliant network. Using f_{Rate(DOCSIS)}, it is possible to calculate a period (T_{Symbol(DOCSIS)}) required to transmit a symbol in the DOCSIS 3.0 compliant network, according to the following equation (4):

T_{Symbol(DOCSIS)}=1/f_{Rate(DOCSIS)}=1/5.120 Msym/s=0.195313 μs. (4)

In accordance with the techniques described in this disclosure, ONTs 16 may reduce, if not eliminate, the occurrence of both of the above described issues through buffering of upstream RF signals received from subscriber devices 18. By buffering these upstream RF signals, ONTs 16 may each introduce a delay into RFOG network 10 equivalent to or exceeding the delay typically required by ONTs 16 to detect the upstream RF signals, e.g., 4 μs. In effect, this delay is introduced or factored into RF network 10 during a process known as “ranging,” which is used to assign upstream transmission timeslots to subscriber devices 18.

Ranging typically involves CMTS/CAS 20 transmitting an RF ranging signal, in turn, to each of subscriber devices 18 and measuring the time it takes each of subscriber devices 18 to respond to the RF ranging signal. Knowing the transmission time of each ONT allows each ONT's transmit time to be adjusted to ensure that transmission arrive at the CMTS in its proper time sequence. Based on this measured time, CMTS/CAS 20 may calculate an approximate distance each of subscriber devices 18 lies from CMTS/CAS 20 and determine a timeslot during which each of subscriber devices 18 may communicate upstream. That is, given the following:

c=299,792,458 meters per second (m/s);

n=1.49,

where c denotes the speed of light in a vacuum and n denotes an index of refraction for silica (or glass of the optical fiber cable), it is possible to calculate the speed of light on the fiber according to equation (7):

v_{light}=c/n=299,792,458 (m/s)/1.49=201,202,991.95 m/s. (7)

Using v_{light}, CMTS/CAS 20 may calculate each of the above described distances according to the following equation (8):

dₙ=(v_{light}*tᵣₑₛₚₒₙₛₑ)/2, (8)

where dₙ represents the distance for the n^{th} one of subscriber devices 18, and tᵣₑₛₚₒₙₛₑ denotes the total time measured from sending the query to the n^{th} one of subscriber devices 18 and receiving a response from that one of subscriber devices 18. Equation (8) calculates the one-way distance. Adding a buffer or other delay, therefore modifies tᵣₑₛₚₒₙₛₑ by increasing tᵣₑₛₚₒₙₛₑ by the time required by ONTs 16 to detect an upstream return path signal, e.g., 4 μs.

Notably, by modifying tᵣₑₛₚₒₙₛₑ, the above distance, dₙ, calculated by CMTS/CAS 20 is also affected such that CMTS/CAS 20 determines a distance dₙ slightly greater than that at which subscriber devices 18 actually lies from CMTS/CAS 20. For example, assuming a delay of 4 μs or that:

t_{Delay}=4 μs,

it is possible to calculate the distance equivalent to the delay or resulting from the delay according to the following equation (9):

d_{Equivalent}=(v_{light}*t_{Delay})/2=402.406 m. (9)

The delay of 4 μs therefore modifies the distance, dₙ, calculated by CMTS/CAS 20 by 402.406 m. DOCSIS 3.0 requires that subscriber devices 18 lie no farther than 80 kilometers (km) from CMTS/CAS 20. As most subscriber devices 18 lie well within this distance (e.g., most lie approximately 30 km or less from CMTS/CAS 20), extending dₙ by such a small amount of approximately 402 meters will not result in ONTs 16 exceeding DOCSIS 3.0 requirements in the vast percentage of deployments. Thus, adding a delay of 4 μs at ONTs 16 typically does not cause DOCSIS 3.0 non-compliance. Moreover, by buffering return path or upstream RF signals, CMTS/CAS 20 may factor in the delay typically required to detect such a signal during the ranging process without resulting in DOCSIS 3.0 non-compliance.

As a result of factoring the delay into this ranging process, CMTS/CAS 20 may determine a timeslot for each of subscriber devices 18 that accounts for the delay typically required to detect an upstream RF signal and assign these timeslots to each of subscriber devices 18. As a result of these modified timeslots, when subscriber devices 18 communicate upstream, each of ONTs 16 may have sufficient time to detect the upstream RF signal, turn on the laser, transmit the optical signal corresponding to the detected upstream RF signal, and turn the laser off, before another one of ONTs 16 turns a laser on and begins transmitting. As no two lasers are like to be on at the same time, OBI and clipping are eliminated and preclude the first issue described above.

ONTs 16, through buffering, also may reduce if not eliminate the second issue involving the irretrievable loss of data and thereby prevent the clipping of upstream RF transmissions or signals. ONTs 16 may include a buffer or other memory to constantly store a set amount of data equal to or exceeding the time typically required by ONTs 16 to detect an upstream RF signal, e.g., 4 μs. That is, each of ONTs 16 may buffer a set amount of data even though none of corresponding subscriber devices 18 are transmitting data, analyze this data, and only turn on the laser upon determining that the buffered data represents a valid upstream RF signal. If determined not to be a valid RF signal, ONTs 16 may write over the data in the buffer. If determined to be a valid RF signal, ONTs 16 begin transmitting all of the data stored in the buffer, thereby preventing the irretrievable loss of any data.

As an example, an ONT, such as ONT 16A, may receive an upstream analog signal, e.g., an RF signal, from a subscriber device, such as subscriber device 18A, during its assigned timeslot. ONT 16A may convert the analog signal into a corresponding digital signal. ONT 16A may then determine whether the upstream analog signal represents a valid upstream communication based on the corresponding digital signal. That is, ONT 16A may analyze the digital signal to determine whether the corresponding upstream analog signal represents a valid upstream communication.

ONT 16A may further include a buffer or other memory to buffer the corresponding digital signal such that none of the analog signal is lost while making the determination. ONT 16A may next convert the buffered digital signal back into the upstream analog signal based on the determination. In other words, upon determining that the buffered analog signal is valid through analysis of the corresponding digital signal, ONT 16A converts the buffered digital signal back into the analog signal so as not to lose any data. ONT 16A may, as described above, include an electrical-to-optical (E-to-O) converter to convert the upstream analog signal into an optical signal and a laser to transmit the optical signal upstream via a fiber optical cable, e.g., fiber optical cable 12. In this manner, ONT 16A may prevent the occurrence of clipping and OBI and the irretrievable loss of data through the use of buffering.

Although described in this disclosure with respect to ONTs 16, the techniques may be implemented by other devices, such as a micronode. “Micronode” may refer to a device, component or module whose function is limited to converting electrical signals to optical signals and optical signals to electrical signals for RF communications at a single customer site. A micronode has a more limited function than an ONT in that its presence on an optical network is typically transparent to both the central office and the service subscribers. Correspondingly, a node provides similar capabilities to a large group of customers (e.g. 250 customers) and a mininode services a small group of customers (e.g. 10 customers). In this respect, ONTs 16 may each comprise a node, mininode or micronode to perform the above described conversions. However, a node, mininode or micronode may, independent of an ONT, perform these conversions. The node, mininode or micronode may, in order to perform these conversions, implement the techniques described in this disclosure.

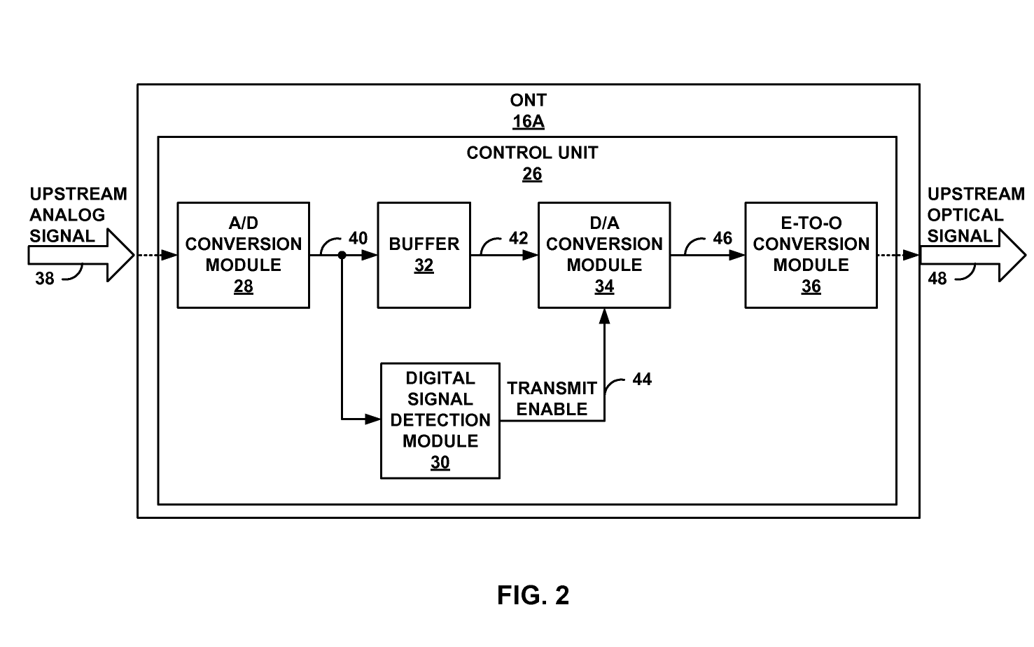

FIG. 2 is a block diagram illustrating an example ONT of FIG. 1 in more detail. While described below with respect to ONT 16A, each of ONTs 16B-16N may include substantially similar modules, elements, components, buffers, converters and other aspects as those described below with respect to ONT 16A.

As shown in FIG. 2, ONT 16A includes a control unit 26. Control unit 26 may represent any combination of hardware, firmware and/or software capable of executing the techniques described in this disclosure. For example, control unit 26 may comprise a programmable processor and a computer-readable storage medium, such as a memory. The computer-readable storage medium may comprise instructions that cause the programmable processor, e.g., by way of executing the instructions, to perform the techniques described in this disclosure. Alternatively or in conjunction with the above exemplary programmable processor and memory, control unit 26 may comprise any combination of one or more processors, multi-core processors, Digital Signal Processors (DSPs), Field Programmable Gate Arrays (FPGAs), microcontrollers, Application Specific Special Processors (ASSPs), or any other type of execution unit. Control unit 26 may also include one or more memories, such as a dynamic (e.g., a Random Access Memory or RAM, a Static RAM or SRAM, a Dynamic RAM or DRAM) and/or a static (e.g., a magnetic drive, an optical drive, a Flash memory, an Erasable Programmable Read-Only Memory or EPROM) memory.

Control unit 26 may include an Analog-to-Digital conversion module 28 (“A/D conversion module 28”), a digital signal detection module 30, a buffer 32, a Digital-to-Analog conversion module 34 (“D/A conversion module 34”), and an Electrical-to-Optical conversion module 36 (“E-to-O conversion module 36”). A/D conversion module 28 converts an analog signal to a corresponding digital signal. In some embodiments, A/D conversion module 28 may be configured to comply with the DOCSIS 3.0 standard. The DOCSIS 3.0 standard requires a Carrier-to-Noise Ratio (CNR) of 32 decibels (dB), where CNR, in the telecommunication context, represents a Signal-to-Noise Ratio (SNR) for a modulated signal. A/D conversion module 28, in this instance, may be configured to sample a given upstream analog signal with a corresponding granularity to enable adequate detection within the required CNR of 32 dB. A/D conversion module 28 may therefore be configured to require six bits to represent a given sample of an upstream analog signal. To determine this six-bit value, the following is assumed:

CNR_{safe}=36 dB; and

QP=6 dB/bit,

where CNR_{safe} denotes a CNR having a safe margin of error over the required CNR of 32 dB, and QP represents a quantization parameter that indicates each 6 dB segment of a signal can be represented by a single bit. Given the above, it is possible to determine the number of bits required to represent a given sample of an upstream analog signal with a 6 dB/bit quantization parameter according to the following equation (10):

N_{AC}=CNR_{safe}/QP=36 dB/(6 dB/bit)=6 bits. (10)

Thus, AD conversion module 28 may be configured to represent a given sample with 6 bits of data.

Digital signal detection module 30 determines, based on the corresponding digital signal output by A/D conversion module 28, whether the upstream analog signal is valid. Buffer 32 stores a configured amount of the digital signal output by A/D conversion module 28. Buffer 32 may be configured to store a particular amount of the digital signal that corresponds with a particular duration of time.

Buffer 32 may be dynamically configured, e.g., based on a detected upstream transmission speed, or statically configured, e.g., by an administrator or other user, by specifying a size of buffer 32. For example, buffer 32 may comprise at least 440 memory locations, which an administrator or other user may determine in the following manner. Typically, to digitize the frequency band of an RF signal (e.g., 5 MHz to 42 MHz), a sampling frequency (f_{Sample}) equal to 110 MHz may be used (Nyquist sampling theory requires a sampling frequency greater than 84 Mhz). Assuming t_{Delay}, as described above, is equal to 4 μs, the number of memory locations (N) can be calculated according to the following equation (11):

N=f_{Sample}*t_{Delay}=110 MHz*4 μs=440. (11)

Thus, buffer 32 may be statically configured to include at least 440 memory locations. A memory location may include the number of bits, N_{ADC}, described above to adequately buffer 440 samples. In this instance, buffer 32 buffers only 4 μs and no more, but buffer 32 may include additional memory locations to account for any additional delay in detecting a signal or for higher sampling frequencies.

Buffer 32 may, in one instance, comprise a First In, First Out (FIFO) buffer. A FIFO buffer operates by outputting the data in the order in which the data was received, such that a first data sample input by the FIFO buffer is also the first data sample output by the FIFO buffer. The FIFO buffer begins to output data samples when the buffer reaches its data capacity, e.g., when the buffer is full. In the example buffer described above as having 440 memory locations, the FIFO buffer may output the first data sample upon receiving the 441^{st} data sample.

D/A conversion module 34 converts the corresponding digital signal back into an analog signal for upstream transmission. A single DSP may be used to implement both A/D conversion module 28 and D/A conversion module 34. E-to-O conversion module 36 converts upstream analog signals received from one or more subscriber devices, e.g., subscriber devices 18A-18M, to optical signals for delivery upstream to, for example, central office 14 via fiber optical cable 12.

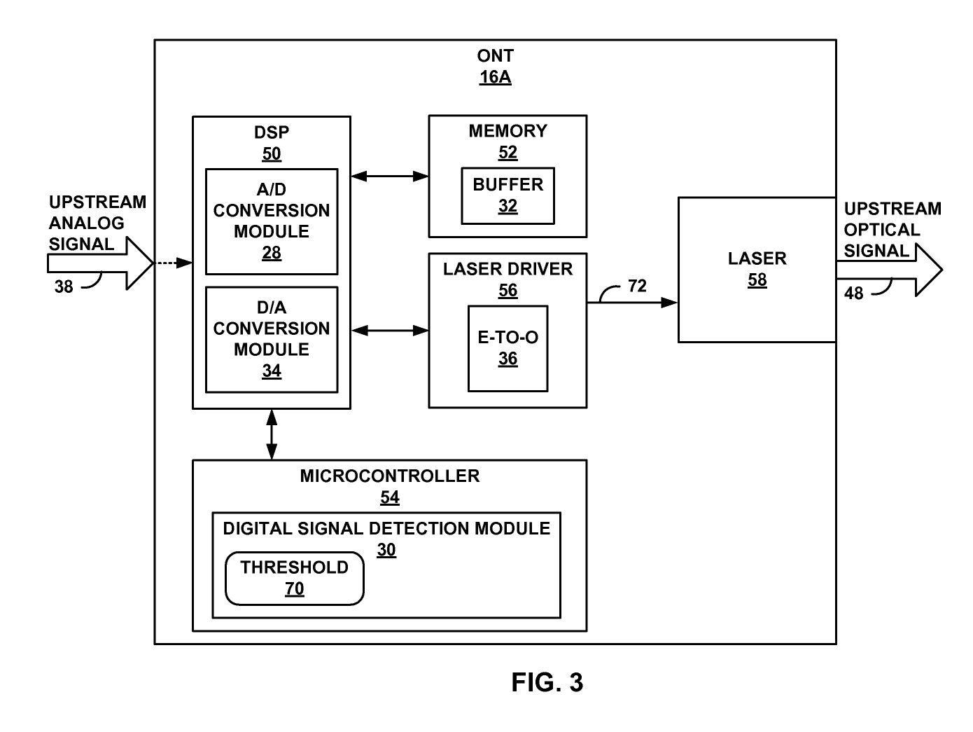

While not shown in FIG. 2, control unit 26 may include additional modules, elements, buffers, and other components for receiving downstream optical signals, converting those optical signals into corresponding downstream analog, e.g., RF, signals (such as the above described O-to-E converter), and transmitting those downstream analog signals to subscriber devices 18A-18M via RF cables 24A-24M. Also not shown in FIG. 2 are various hardware and/or software required for actual receipt and transmission of signals. In this respect, FIG. 2 represents a logical diagram detailing the interaction of various modules, buffers, and other components without reference to the underlying hardware and/or software. An exemplary return or upstream architecture is described below with respect to FIG. 3.

In operation, control unit 26 receives an upstream analog signal 38 from one of subscriber devices 18A-18M during a respective timeslot assigned to the transmitting one of subscriber devices 18A-18M. In particular, A/D conversion module 28 of control unit 26 may receive upstream analog signal 38. In some instances, A/D conversion module 28 may not directly receive signal 38. Instead, ONT 16A may comprise other intermediate hardware that performs pre-processing on upstream analog signal 38 or otherwise handles upstream analog signal 38 before it arrives at control unit 26. FIG. 2 represents this indirect receipt of signal 38 by depicting the traversal of signal 38 as a dashed line.

A/D conversion module 28 converts upstream analog signal 38 to a corresponding digital signal 40 according to standard, typical or conventional A/D conversion algorithms. Digital signal 40 “corresponds” to upstream analog signal 38 in that it represents a digital manifestation or representation of analog signal 38. A/D conversion module 28 may, for example, sample analog signal 38 to generate corresponding digital signal 40. Typically, A/D conversion module 28 samples the upstream analog signal 38 at a rate at least twice the frequency of analog signal 38 to ensure accurate representation of analog signal 38 as corresponding digital signal 40. Digital signal 40 may comprise a plurality of the above described six bit samples, which may be referred to herein as a “stream” of six-bit samples. A/D conversion module 28 may output digital signal 40 to both digital signal detection module 30 and buffer 32.

Digital signal detection module 30 may analyze digital signal 40 to determine whether the received upstream analog signal 38 is valid. Digital signal detection module 30 may, for example, analyze corresponding digital signal 40 to determine whether upstream analog signal 38 is valid by comparing digital signal 40 to a configurable threshold. Detecting the presence of an upstream RF transmission from the digital representation can be done in a number of ways. For example, digital signal detection module 30 can digitally determine an upstream signal envelope amplitude or an upstream power level. The threshold may be configured to a declare the presence of a signal when the computed envelope level exceeds a “no signal” envelope level by a set level, e.g., 10 dB, or an upstream power level. When one or more of the six-bit samples of digital signal 40 indicate an envelope amplitude that equals or exceeds the threshold, digital signal detection module 30 determines digital signal 40 is valid. However, when the one or more of the six bit samples of digital signal 40 are less than the threshold, digital signal detection module 30 determines digital signal 40 is not valid. This threshold may be statically configured by the administrator or other user or dynamically configured by control unit 26. With respect to the dynamic configuration of the threshold, digital signal detection module 30 may monitor digital signal 40 and determine an average level of noise present on digital signal 40 to configure the threshold just above or equal to the average level of noise. In this manner, digital signal detection module 30 may dynamically detect, through analysis of corresponding digital signal 40, whether upstream analog signal 38 is valid.

In effect, digital signal detection module 30 may attempt to detect whether there is a power on one of RF cables 24A-24M, and the threshold, as a result, may be referred to as a “power” threshold. While conventional ONTs typically employ statically configured analog circuits to detect this power, ONT 16A, by way of digital signal detection module 30, may perform a digital analysis of corresponding digital signal 40. Digital analysis may enable ONT 16A to detect valid upstream signals more quickly. Additionally, digital analysis may enable ONT 16A to dynamically adapt the threshold to adjust for varying levels of noise on RF cables 24A-24M. In some embodiments, digital signal detection module 30 may maintain a separate threshold for each of cables 24A-24M, input interface (not shown) and/or subscriber devices 18A-18M.

While digital signal detection module 30 determines whether upstream analog signal 38 is valid, buffer 32 stores or buffers corresponding digital signal 40. Buffer 32 may comprise a ring or circular buffer implemented in hardware, software, or both hardware and software or any other type of buffer or storage system capable of storing fixed amounts of data for delayed processing. Buffer 32 may represent a high-speed memory, such as RAM, SRAM, DRAM and similar highly-accessible memories, and software, e.g., a data structure, to manage at least a portion of the high-speed memory. Buffer 32 may comprise enough storage space to buffer an amount of data or symbols equal to or exceeding a delay experienced by ONT 16A.

ONT 16A may experience a delay, for example, while digital signal detection module 30 detects whether upstream analog signal 38 is valid. This delay may be equal to or greater than the above described 4 μs. The delay to detect upstream analog signal 38 may arise due in part to difficulty detecting initial segments of upstream analog signal 38. That is, subscriber devices 18 may initially transmit malformed or clipped segments of upstream analog signal 38 that are difficult to detect as a valid upstream analog signal 38. Digital signal detection module 30 may not be able to readily detect these malformed segments as valid due in part to these malformed segments having reduced power or magnitude, thereby making it difficult to distinguish the malformed segments from noise. As a result, digital signal detection module 30 may base the determination on whether upstream analog signal 38 on later segments that are not malformed, and consequently more easily distinguishable from noise. These later segments generally arrive around 4 μs after the initial malformed segments and buffer 32 may buffer both the digital representation of the malformed segments and the later segments as digital signal 40 so as not to lose any data.

Buffer 32 may output buffered digital signal 42 either continuously or in response to a signal, such as transmit enable signal 44. For example, buffer 32 may comprise a FIFO buffer that, after reaching capacity, continuously outputs data samples as new data samples are received from A/D conversion module 28. Although not shown as receiving transmit enable signal 44 in the exemplary embodiment illustrated in FIG. 2, buffer 32 may in another example embodiment receive transmit enable signal 44 from digital signal detection module 30 and be activated to output buffered digital signal 42 in response to transmit enable signal 44.

If digital signal detection module 30 determines, based on digital signal 40, that upstream analog signal 38 is not valid, digital signal detection module 30 may not issue transmit enable signal 44 or may issue transmit enable signal 44 in a manner that causes D/A conversion module 34 not to output a reconverted upstream analog signal 46. For example, digital detection module 30 may not raise, or rather keep, transmit enable signal 44 at a low state to indicate upstream analog signal 38 is not valid. However, if digital signal detection module 30 determines, based on digital signal 40, that upstream analog signal 38 is valid, digital signal detection module 30 may issue transmit enable signal 44 or may issue transmit enable signal 44 in a manner that causes D/A conversion module to output reconverted upstream analog signal 46. For example, digital detection module 30 may raise the transmit enable signal 44 to a high state to indicate upstream analog signal 28 is valid. As described above, digital signal detection module 30 may, alternatively, issue the signal to buffer 32 instead of D/A conversion module 34 or to both buffer 32 and D/A conversion module 34 in order to cause D/A conversion module 34 to output reconverted upstream analog signal 46.

Assuming digital signal detection module 30 determines that analog signal 38 is valid and issues transmit enable signal 44, D/A conversion module 34 converts buffered digital signal 42 received from buffer 32 to upstream analog signal 46, which may be substantially similar, if not identical, to upstream analog signal 38. Digital signal detection module 30 outputs this signal 38 as reconverted upstream analog signal 46 to E-to-O conversion module 36. E-to-O conversion module 36 converts reconverted upstream analog signal 46 to an optical signal, which control unit 26 outputs as upstream optical signal 48 for transmission upstream to central office 14. Again, the dashed line from E-to-O conversion module 36 to upstream optical signal 48 indicates such transmission may be indirect. That is, various hardware and/or software processing may be done to generate and transmit upstream optical signal 48 from the signal output by E-to-O conversion module 36.

By implementing the techniques described in this disclosure, ONT 16A may include a plurality of modules that conventional ONTs typically do not require to convert RF signals to optical signals, such as A/D conversion module 28, digital signal detection module 30, buffer 32, and D/A conversion module 34. This digital conversion implemented by ONT 16A therefore may replace the analog implementation of conventional ONTs, which enables ONT 16A to overcome OBI and the irretrievable data loss that typically occurs when such conventional ONTs are introduced into DOCSIS 3.0 compliant networks. Moreover, this digital conversion performed by ONT 16A may enable a more fine-grained detection of RF signals by way of a dynamically adjustable detection threshold, which may be controllable by ONT 16A through proper A/D converter selection. By allowing a lower minimum threshold, ONTS 16A may enable subscriber devices 18 to transmit at a much lower RF power, which may improve the range of upstream power levels the system can operate over, a characteristic called the system dynamic range, which, in some instances, is a parameter of critical importance in RF return systems.

Further, ONTs that implement the techniques described in this disclosure, such as ONT 16A, may overcome significant limitations when compared to conventional ONTs. By converting analog signals to digital, ONT 16A may reduce costs in that sampled data systems, or digital systems, are typically simpler to manufacture and test than corresponding analog systems. Digital systems, such as those employed by ONT 16A may also be subject to less parametric variations that naturally occur in analog systems, such as those employed by convention ONTs. Also, digital systems, by virtue of their dynamic configuration, may enable the administrator or other users to select and deliver any level of DOCSIS or ANSI/SCTE service they desire. In addition, the DOCSIS 3.0 standard requires 64 Quadrature Amplitude Modulation (QAM) or 64 QAM. As A/D converters or A/D conversion modules may be routinely used to construct an inexpensive QAM demodulator, ONT 16A, by including A/D conversion module 28, may be inexpensively and conveniently adapted to support both 64 QAM to comply with the DOCSIS 3.0 standard.

The various components of control unit 26 illustrated in FIG. 2 may be realized in hardware, software or any combination thereof. Some components may be realized as processes or modules executed by one or more microprocessors or digital signal processors (DSPs), one or more application specific integrated circuits (ASICs), one or more field programmable gate arrays (FPGAs), or other equivalent integrated or discrete logic circuitry. Depiction of different features as modules is intended to highlight different functional aspects of control unit 26 and does not necessarily imply that such modules must be realized by separate hardware or software components. Rather, functionality associated with one or more modules may be integrated within common or separate hardware or software components. Thus, the disclosure should not be limited to the example of control unit 26.

FIG. 3 is a block diagram illustrating an example embodiment of ONT 16A of FIGS. 1 and 2 in further detail. FIG. 3 provides an exemplary physical implementation or architecture of ONT 16A. This physical implementation should not be construed as limiting to the techniques described in this disclosure. While described below with respect to ONT 16A, each of ONTs 16 may comprise physical implementations substantially similar to that described below with respect to ONT 16A.

As shown in the exemplary physical implementation of FIG. 3, ONT 16A includes a digital signal processor 50 (“DSP 50”) that implements A/D conversion module 28 and D/A conversion module 34, a memory 52 that implements buffer 32, a microcontroller 54 that implements digital signal detection module 30, a laser driver 56 that includes E-to-O conversion module 36 and a laser 58. Operation of A/D conversion module 28, D/A conversion module 34, buffer 32, digital signal detection module 30, and E-to-O conversion module 36 is described in detail with respect to FIG. 2. Laser 56 may represent any laser or light emitting device that conveys data via one or more wavelengths via a fiber optical cable, such as fiber optical cable 12 of FIG. 1.

Although described in detail above, DSP 50 may receive upstream analog signal 38 and convert upstream analog signal 38 to a corresponding digital signal 40 via A/D conversion module 28. After converting upstream analog signal 38, DSP 50 may store the digital signal 40 to buffer 32 of memory 52. DSP 50 may also output the digital signal 40 to microcontroller 54, which executes digital signal detection module 30 to determine, based on digital signal 40, whether upstream analog signal 38 is valid. In some instances, digital signal detection module 66 compares signal 40 or a derivative thereof (such as might result from analysis of signal 40) to a threshold 70 that may be either statically configured by an administrator or other user or dynamically adapted based on, for example, an average level of noise monitored from digital signal 40.

If analog signal 38 is determined not to be valid, e.g., a CNR or power level of digital signal 40 is less than threshold 70, digital signal detection module 66 may not transmit a transmit enable signal 44. Otherwise, digital signal detection module 66 transmits transmit enable signal 44 to DSP 50, which then begins converting corresponding digital signal stored to buffer 64, e.g., buffered digital signal 42, back to upstream analog signal 38 using D/A conversion module 62. DSP 50 may output this reconverted upstream analog signal 38 as a reconverted upstream analog signal, e.g., signal 46, to laser driver 56. Laser driver 56 employs E-to-O converter 68 to convert reconverted upstream analog signal 46 to impulse signal 72, which drives laser 58 to transmit upstream optical signals 48.

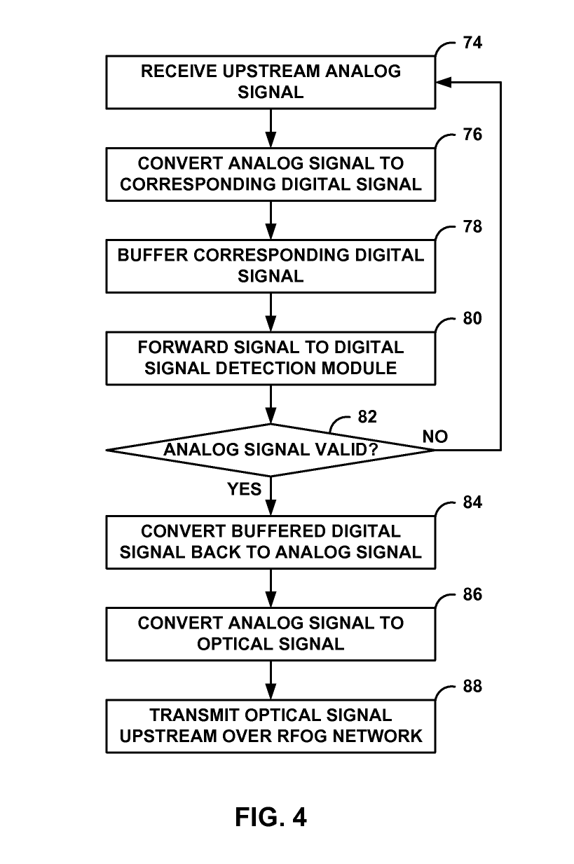

FIG. 4 is a flow diagram illustrating example operation of an ONT, such as ONT 16A of FIG. 2, performing the techniques described in this disclosure. As described above, control unit 26 of ONT 16A initially receives, either directly or indirectly, an upstream analog signal 38 from one of subscriber devices (74). As shown in FIG. 2, subscriber devices 18A-18M couple via RF cables 24A-24M to ONT 16A. However, one or more subscriber devices 18A-18M may share the same RF cable or subscriber devices 18A-18M may communicate wirelessly with ONT 16A via a standard wireless communication protocol, such as one defined by the 802.X family of standards.

Regardless of how ONT 16A receives upstream analog signal 38, A/D conversion module 28 of control unit 26 converts upstream analog signal 38 to a corresponding digital signal 40 (76). A/D conversion module 28 then stores or buffers corresponding digital signal 40 to buffer 32 (78). A/D conversion module 28 also forwards digital signal 40 to digital signal detection module 30 (80).

Digital signal detection module 30 determines, based on digital signal 40, whether upstream analog signal 38 is valid in the manner described above (82). Digital signal detection module 30 may, for example, determine whether upstream analog signal 38 is valid by comparing digital signal 40 to a threshold. If upstream analog signal 38 is not valid, e.g., digital signal 40 is less than the threshold, digital signal detection module 30 does not assert transmit enable signal 44 or otherwise cause or trigger D/A conversion module 34 to begin converting buffered digital signal 42 to reconverted upstream analog signal 46. As a result, A/D conversion module 28 continues to receive upstream analog signal 38 (74), convert upstream analog signal 38 to corresponding digital signal 40 (76), buffer corresponding digital signal 40 to buffer 32 (78), and forward corresponding digital signal 40 to digital signal detection module 30 (80). Buffer 32 may buffer corresponding digital signal 40 by writing over older portions of corresponding digital signal 40. As described above, buffer 32 may comprise a circular buffer, e.g., FIFO buffer, which enables seamless writing over or replacement of older data with more recent or newer data.

If digital signal detection module 30 determines that upstream analog signal 38 is valid, e.g., of the power of digital signal 40 is greater than or equal to the threshold, D/A conversion module 34 converts buffered digital signal 42 back to an analog signal (84). D/A conversion module 34 outputs this reconverted upstream analog signal 46 to E-to-O conversion module 36, which converts signal 46 to an optical signal (86). ONT 16A transmits the optical signal upstream via optical fiber link 12 (88).

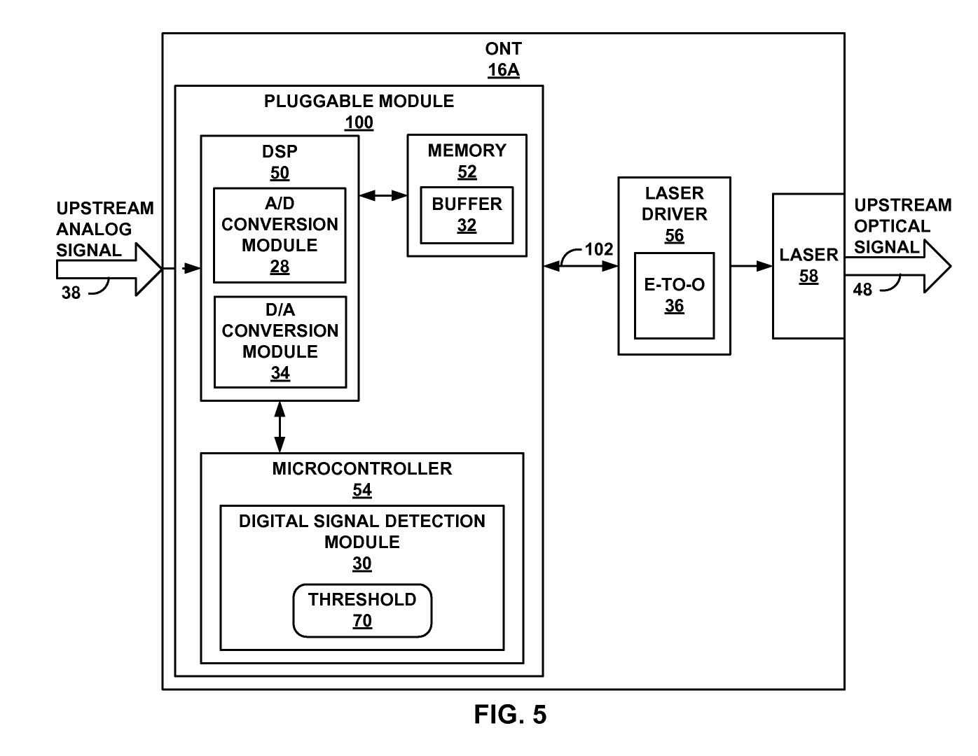

FIG. 5 is a block diagram illustrating another example physical implementation of ONT 16A of FIGS. 1 and 2. This implementation is similar to that described above with respect to FIG. 3 in that ONT 16A comprises a DSP 50, a memory 52, and a microcontroller 54, a laser driver 56 and a laser 58. However, ONT 16A of FIG. 5 implements DSP 50, memory 52, and microcontroller 54 within a separate pluggable module 100. Pluggable module 100 may comprise a card that is inserted into a slot or other interface or any other module capable of being inserted and removed without requiring removal of other elements or modules of ONT 16A. Once plugged in or otherwise inserted into ONT 16A, pluggable module 100 couples to communication medium 102 for communicating information to laser driver 96. Communication medium 102 may comprise a switch plane, a bus, or any other type of medium used for connecting removable modules, such as pluggable module 100, to fixed elements, such as laser driver 96.

Because pluggable module 100 may be, in some instances, quickly inserted, conventional ONTs providing an interface that accepts pluggable module 100 may be quickly upgraded to enable these conventional ONTs 16A to support the DOCSIS 3.0 standard. Moreover, given that pluggable module 100 may be, in some instances, quickly removed, ONTs 16A may be transitioned from supporting RFOG networks to fully optical networks without replacing ONT 16A in its entirety. Pluggable module 100 therefore may further limit costs associated with converting RFOG network 10 to a fully optical network.

While described above within the context of the ANSI/SCTE 55-1 and 55-2 and DOCSIS 3.0 standards, the techniques may enable ONT 16A to provide a return path compliant with any standard governing optical, HFC, coaxial, RFOG, or any other network, as well as, standards governing the design of subscriber devices 18. For example, buffer 32 and DSP 50 or, more particularly, A/D conversion module 28 may be configured to support any required return path rate. Microcontroller 54 or, more particularly, digital signal module detection module 30 may be configured with or adapt a threshold 70 to enable faster detection of upstream RF signals to suit any of these standards. As a result of this configurability, ONT 16A may adapt to such standards as those described above, as well as, DOCSIS 1.0, 1.1, and 2.0.

The techniques described herein may be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. If implemented in hardware, this disclosure may be directed to an apparatus such a processor or an integrated circuit device, such as an integrated circuit chip or chipset. Alternatively or additionally, if implemented in software, the techniques may be realized at least in part by a computer-readable medium comprising instructions that, when executed, cause a processor to perform one or more of the methods described above. For example, the computer-readable medium may store such instructions.

A computer-readable medium may form part of a computer program product, which may include packaging materials. A computer-readable medium may comprise a computer data storage medium such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be executed by one or more processors, such as one or more DSPs, general purpose microprocessors, ASICs, field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules.

Various embodiments have been described. These and other embodiments are within the scope of the following claims.

1. A method comprising:
converting an upstream analog signal into a corresponding digital signal;
determining whether the upstream analog signal represents a valid upstream communication based on the corresponding digital signal;
buffering the corresponding digital signal while making the determination;
converting the buffered digital signal into a reconverted upstream analog signal upon determining that the upstream analog signal is a valid upstream communication; and
transmitting the reconverted upstream analog signal via a fiber optical cable.

2. The method of claim 1, further comprising receiving the upstream analog signal from a subscriber device, wherein the upstream analog signal comprises an upstream radio frequency (RF) signal.

3. The method of claim 1 wherein buffering the corresponding digital signal comprises buffering the corresponding digital signal such that no part of the analog signal is lost while making the determination.

4. The method of claim 1, wherein receiving the upstream analog signal includes receiving the upstream analog signal at a return path rate that exceeds 128 Kilo-symbols per second.

5. The method of claim 1, wherein receiving the upstream analog signal includes receiving an upstream analog signal at a return path rate of at least 5.120 Mega-symbols per second.

6. The method of claim 1, wherein
determining whether the upstream analog signal represents a valid upstream communication includes comparing a power level of the corresponding digital signal to a threshold power level, and
converting the buffered digital signal includes converting the buffered digital signal into the reconverted upstream analog signal if the power level of the corresponding digital signal equals or exceeds the threshold power level.

7. The method of claim 1, wherein converting the upstream analog signal into the corresponding digital signal includes sampling the upstream analog signal with an analog-to-digital (A/D) converter at a frequency of at least 110 Mega Hertz (MHz).

8. The method of claim 1, wherein buffering the corresponding digital signal comprises buffering the corresponding digital signal with a buffer configured to store at least about 4 microseconds (μs) of the corresponding digital signal.

9. The method of claim 1, wherein transmitting the reconverted upstream analog signal comprises:
converting the reconverted upstream analog signal into an optical signal; and
transmitting the optical signal upstream via the fiber optical cable.

10. The method of claim 1, further comprising receiving the upstream analog signal from a device during a timeslot assigned to the device,
wherein the timeslot specifies a duration during which the device transmits the upstream analog signal, and
wherein buffering the corresponding digital signal extends the duration of the timeslot assigned to the device.

11. The method of claim 1, further comprising:
configuring a sampling frequency used in the conversion of an upstream analog signal into a corresponding digital signal;
configuring a threshold used in the determination of whether the upstream analog signal is the valid upstream communication; and
configuring a size of a buffer used to buffer the corresponding digital signal.

12. A device comprising:
a first conversion module that converts an upstream analog signal into a corresponding digital signal;
a signal detection module that determines whether the upstream analog signal represents a valid upstream communication based on the corresponding digital signal;
a buffer that buffers the corresponding digital signal while the signal detection module makes the determination;
a second conversion module that converts the buffered digital signal into a reconverted upstream analog signal upon the signal detection module determining that the upstream analog signal is a valid upstream communication; and
a laser that transmits the reconverted upstream analog signal via a fiber optical cable.

13. The device of claim 12, wherein the first and second conversion modules are included within the same Digital Signal Processor (DSP).

14. The device of claim 12, wherein the device comprises a pluggable optical module within an Optical Network Terminal (ONT).

15. The device of claim 12, wherein the first conversion module further receives the upstream analog signal from a subscriber device by receiving an upstream radio frequency (RF) signal.

16. The device of claim 12, wherein the buffer buffers the corresponding digital signal by buffering the corresponding digital signal such that no part of the analog signal is lost while making the determination.

17. The device of claim 12, wherein the first conversion module further receives the upstream analog signal by receiving the upstream analog signal at a return path rate that exceeds 128 Kilo-symbols per second.

18. The device of claim 12, wherein the first conversion module further receives the upstream analog signal by receiving an upstream analog signal at a return path rate of at least 5.120 Mega-symbols per second.

19. The device of claim 12,
wherein the signal detection module determines whether the upstream analog signal represents the valid upstream communication by comparing a power level of the corresponding digital signal to a threshold power level, and
wherein the second conversion module converts the buffered digital signal by converting the buffered digital signal into the reconverted upstream analog signal if the power level of the corresponding digital signal equals or exceeds the threshold level.

20. The device of claim 12, wherein the first conversion module comprises an analog-to-digital (A/D) converter that converts the upstream analog signal into the corresponding digital signal by sampling the upstream analog signal at a frequency greater than a required Nyquist rate.

21. The device of claim 12, wherein the buffer includes a buffer configured to store about 4 microseconds (μs) of the corresponding digital signal.

22. The device of claim 12, wherein the laser that transmits the reconverted upstream analog signal comprises:
a laser driver that converts the reconverted upstream analog signal into an optical signal; and
a laser that transmits the optical signal upstream via the fiber optical cable.

23. The device of claim 12,
wherein the first conversion module further receives the upstream analog signal from another device during a timeslot assigned to the other device,
wherein the timeslot specifies a duration during which the other device transmits the upstream analog signal, and
wherein the buffering performed by the buffer extends the duration of the timeslot assigned to the other device.

24. The device of claim 12,
wherein the first conversion module is configured with a sampling frequency used in the conversion of an upstream analog signal into a corresponding digital signal;
wherein the signal detection module is configured with a threshold used in the determination of whether the upstream analog signal is the valid upstream communication; and
wherein the buffer is configured with a size of the buffer used in the buffering of the corresponding digital signal.

25. The device of claim 12, wherein the device comprises an Optical Network Terminal (ONT) and resides within a Radio Frequency Over Glass (RFOG) network that complies with a Data Over Cable Service Interface Specification (DOCSIS) 3.0 standard by requiring one or more subscriber devices and the ONT to communicate the upstream analog signal according to a DOCSIS 3.0 compliant return path rate.

26. A device comprising:
a first means for converting an upstream analog signal into a corresponding digital signal;
a means for determining whether the upstream analog signal represents a valid upstream communication based on the corresponding digital signal;
a means for buffering the corresponding digital signal while the signal detection module makes the determination;
a second means for converting the buffered digital signal into a reconverted upstream analog signal upon the signal detection module determining that the upstream analog signal is a valid upstream communication;
a means for transmitting the reconverted upstream analog signal via a fiber optical cable.

27. The device of claim 26, wherein the first and second conversion means are included within the same Digital Signal Processor (DSP).

28. The device of claim 26, wherein the device comprises a pluggable optical module within an Optical Network Terminal (ONT).

29. The device of claim 26, wherein the first means for converting further includes means for receiving the upstream analog signal from a subscriber device, wherein the upstream analog signal includes an upstream radio frequency (RF) signal.

30. The device of claim 26, wherein the means for buffering the corresponding digital signal includes means for buffering the corresponding digital signal such that no part of the analog signal is lost while making the determination.

31. The device of claim 26, wherein the first conversion means includes means for receiving the upstream analog signal, wherein means for receiving the upstream analog signal receives the upstream analog signal a return path rate that exceeds 128 Kilo-symbols per second.

32. The device of claim 26, wherein the first conversion means includes means for receiving the upstream analog signal by receiving an upstream analog signal at a return path rate of at least 5.120 Mega-symbols per second.

33. The device of claim 26,
wherein the means for determining whether the upstream analog signal represents the valid upstream communication includes means for comparing a power level of the corresponding digital signal to a threshold power level, and
wherein the second means for converting the buffered digital signal includes means for converting the buffered digital signal into the reconverted upstream analog signal if the power level of the corresponding digital signal equals or exceeds the threshold power level.

34. The device of claim 26, wherein the first means for converting includes an analog-to-digital (A/D) converter that converts the upstream analog signal into the corresponding digital signal by sampling the upstream analog signal at a frequency greater than a required Nyquist rate.

35. The device of claim 26, wherein the means for buffering includes a buffer configured to store about 4 microseconds (μs) of the corresponding digital signal.

36. The device of claim 26, wherein the means for transmitting the reconverted upstream analog signal comprises:
a laser driver that converts the reconverted upstream analog signal into an optical signal; and
a laser that transmits the optical signal upstream via the fiber optical cable.

37. The device of claim 26,
wherein the first means for converting includes means for receiving the upstream analog signal from another device during a timeslot assigned to the other device,
wherein the timeslot specifies a duration during which the other device transmits the upstream analog signal, and
wherein the means for buffering extends the duration of the timeslot assigned to the other device.

38. The device of claim 36, further comprising:
wherein the first means for converting is configured with a sampling frequency used in the conversion of an upstream analog signal into a corresponding digital signal;
wherein the means for determining is configured with a threshold used in the determination of whether the upstream analog signal is the valid upstream communication; and
wherein the means for buffering is configured with a size of the buffer used in the buffering of the corresponding digital signal.

39. The device of claim 36, wherein the device comprises an Optical Network Terminal (ONT) and resides within a Radio Frequency Over Glass (RFOG) network that complies with a Data Over Cable Service Interface Specification (DOCSIS) 3.0 standard by requiring one or more subscriber devices and the ONT to communicate the upstream analog signal according to a DOCSIS 3.0 compliant return path rate.

40. A system comprising:
at least one subscriber device that transmits an upstream analog signal;
a network; and
a device coupled to the network via a fiber optical cable, wherein the device comprises:
a first conversion module that converts the upstream analog signal into a corresponding digital signal;
a signal detection module that determines whether the upstream analog signal represents a valid upstream communication based on the corresponding digital signal;
a buffer that buffers the corresponding digital signal while the signal detection module makes the determination;
a second conversion module that converts the buffered digital signal into a reconverted upstream analog signal upon the signal detection module determining that the upstream analog signal is a valid upstream communication;
a laser that transmits the reconverted upstream analog signal via the fiber optical cable.

41. The system of claim 40, wherein the buffer buffers the corresponding digital signal by buffering the corresponding digital signal such that no part of the analog signal is lost while making the determination.

42. The system of claim 40, wherein the first conversion module further receives the upstream analog signal by receiving the upstream analog signal at a return path rate that exceeds 128 Kilo-symbols per second.

43. The system of claim 40, wherein the first conversion module further receives the upstream analog signal by receiving an upstream analog signal at a return path rate of at least 5.120 Mega-symbols per second.

44. The system of claim 40,
wherein the signal detection module determines whether the upstream analog signal represents the valid upstream communication by comparing a power level of the corresponding digital signal to a threshold power level, and
wherein the second conversion module converts the buffered digital signal by converting the buffered digital signal into the reconverted upstream analog signal if the power level of the corresponding digital signal equals or exceeds the threshold power level.

45. The system of claim 40, wherein the buffer includes a buffer configured to store about 4 microseconds (μs) of the corresponding digital signal.

46. The system of claim 40,
wherein the first conversion module further receives the upstream analog signal from the at least one subscriber device during a timeslot assigned to the subscriber device,
wherein the timeslot specifies a duration during which the subscriber device transmits the upstream analog signal, and
wherein the buffering performed by the buffer extends the duration of the timeslot assigned to the subscriber device.

47. A computer-readable medium comprising instructions that cause a programmable processor to:
convert an upstream analog signal into a corresponding digital signal;
determine whether the upstream analog signal represents a valid upstream communication based on the corresponding digital signal;
buffer the corresponding digital signal while making the determination;
convert the buffered digital signal into a reconverted upstream analog signal upon determining that the upstream analog signal is a valid upstream communication; and
transmit the reconverted upstream analog signal via a fiber optical cable.

48. The computer-readable medium of claim 47, wherein the instructions cause the processor to buffer the corresponding digital signal by buffering the corresponding digital signal such that no part of the analog signal is lost while making the determination.

49. The computer-readable medium of claim 47, wherein the instructions cause the processor to further receive the upstream analog signal at a return path rate that exceeds 128 Kilo-symbols per second.

50. The computer-readable medium of claim 47, wherein the instructions cause the processor to further receive the upstream analog signal at a return path rate of at least 5.120 Mega-symbols per second.

51. The computer-readable medium of claim 47, wherein the instructions cause the processor to buffer the corresponding digital signal by buffering the corresponding digital signal with a buffer configured to store about 4 microseconds (μs) of the corresponding digital signal.

52. The computer-readable medium of claim 47,
wherein the instructions cause the processor to further receive the upstream analog signal from a subscriber device during a timeslot assigned to the device,
wherein the timeslot specifies a duration during which the device transmits the upstream analog signal, and
wherein the instructions that cause the processor to buffer the corresponding digital signal extend the duration of the timeslot assigned to the device.
